(19) United States
(12) Patent Application Publication
(10) Pub. No.: US 2015/0265928 A1
(43) Pub. Date: Sep. 24, 2015

(54) GAME BEHAVIOR BONDS

(71) Applicant: Sony Computer Entertainment America LLC, San Mateo, CA (US)

(72) Inventor: Edward Adam Lerner, San Francisco, CA (US)

(73) Assignee: Sony Computer Entertainment America LLC, San Mateo, CA (US)

(21) Appl. No.: 14/221,351

(22) Filed: Mar. 21, 2014

(51) Int. Cl. A63F 13/792

(52) U.S. Cl. CPC A63F 13/792

(57) ABSTRACT

Computer-implemented methods and systems for processing of behavior bonds are provided. An example method comprises coding bond rules for a platform or specific application or contest; registering a user with a platform, application or contest to create the necessary user data; calculating which behavior rules the user must abide, based on the user data and Bond rules; receiving, from administrators, leaders, other users, applications or systems, information related to user behavior for any current behavior bonds; updating, based on user actions and reports the then current user behavior bonds status, deducting penalties as necessary; displaying the behavior bonds as necessary and disbursing any forfeited behavior bonds.

### TECHNICAL FIELD

This disclosure relates generally to data processing, and more specifically to methods and systems for bonding participants in multi-user applications and games via a deposit or payment.

### BACKGROUND

One of the key factors to enjoying a multi-player game or application is the behavior of the other participants. Rude behavior of other participants can reduce enjoyment. For instance, players may drop out of games when they start to fall behind, which may ruin the experience for others on their team.

Existing solutions may penalize rude or bad behavior via reducing score or reputation points. This can be helpful when you can choose which player you want on your team, and reject players with poor reputation. However many games don't allow players to choose all their team mates, and new players won't have a reputation based on their game history.

The present invention is directed to a novel method of discouraging rude or otherwise unwanted behavior, based on behavior bonds.

### SUMMARY

This summary is provided to introduce a selection of concepts in a simplified form that are further described below. This summary is not intended to identify key features or essential features of the claimed subject matter, nor is it intended to be used as an aid in determining the scope of the claimed subject matter.

The present invention is directed to a computer implemented method for processing behavior bonds. The method comprises the steps of: setting bond rules for one of a platform, specific application, contest or game; registering a user with one of the platform, application, contest or game to create user data; determining which behavior rules the user must follow based on the user data and bond rules; receiving, from administrators, leaders, other users, applications or systems, information related to user behavior from any current behavior bonds; updating, based on user actions and reports, the current user behavior bonds status and detecting penalties as necessary; displaying the behavior bonds remaining; and dispersing any forfeited behavior bonds.

The user may deposit a bond into an escrow account.

The number of rule violations for each user is determined and displayed.

The forfeited bonds are shared among all players without a violation.

The forfeited bonds are dispersed as a prize.

The bond is used to grant additional privileges to the user.

The bond may be associated with virtual objects.

If a violation is determined, the user is warned about the violation.

If a violation is determined and is determined not to be serious, the amount of the bond refunded to the use is reduced.

If a serious violation is determined, the amount of the bond is forfeited by the user.

To the accomplishment of the foregoing and related ends, the one or more embodiments comprise the features hereinafter fully described and particularly pointed out in the claims. The following description and the drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram showing an environment within which a method and system for behavior bonds can be implemented, in accordance with an example embodiment.

FIG. 2 shows a flow chart of a method for processing behavior bonds, in accordance with some example embodiments.

FIG. 3 shows a detailed block diagram of the system for processing behavior bonds, in accordance with an example embodiment.

FIG. 4 shows a detailed block diagram of one of the steps of FIG. 2.

FIG. 5 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to he taken in a limiting sense, and the scope is defined by the appended claims and their equivalents.

In applications or games where participant behavior is important, application designers can offer behavior bonding via payment of a refundable deposit.

In one form of bonding, participants are asked to place a small bond or deposit into an escrow account, typically built into the game application. For instance players may be asked to place a $1 deposit into a team's escrow account before joining that team. The player's escrow will be refunded upon a normal exit from the team. However, if the team member did not. act according to team policy or the desires of team leadership, the team leadership could be given the discretion to fine that player any amount up to the deposit. Statistics could be kept and displayed on the team's use of fines to inform potential new members of the team about the team's reputation, in such matters.

In another example, players may be asked to place a $5 deposit into a contest's escrow account before joining that contest. The player's escrow will be refunded upon a normal exit from the contest. However, if the player did not abide by the rules of the contest some or all of their contest deposit could be subject to loss.

If a player loses some or all of their deposit, the application designer may choose where that deposit goes. In one method, the lost deposits go into a pool that is shared among all other non-fined participants. In another method, lost deposits are collected and included in some sort of prize.

Example of discouraged behaviors might include:
Dropping out of multiplayer matches
Excessive rudeness
Throwing or purposefully losing a game

Bonds or deposits may be increased at more serious levels of responsibility or competition. For instance, a global championship with a $10,000 prize may require a $100 bond or deposit.

Bonds or deposits might also be required to grant additional responsibilities or privileges. For instance a participant could be granted a set of privileges including the right to message a very large group, in return for a $10 bond.

Bonds could be reserved for users with a history of behavior problems. For instance a user, who has been caught abusing other players, might lose their ability to message other users, unless the user places a $10 bond on this ability. The bond might double each time the user forfeited the bond for cause.

Cash bonds may not be the only deposit used. In some applications, particularly virtual worlds, it may be more effective or fictionally consistent to use virtual objects as bonds. For instance a player in a virtual world might have to place a deposit of 100 gold pieces, or their best weapon, to enter a behavior restricted area of a game world.

The threat of loss of a bond may also be a useful tool to discourage had user behavior. Application designers may offer to system developers, moderators, team leaders, etc, interfaces that allow systems to either warn or penalize, and explain the cause of these warning or penalties.

As users may vary by sensitivity to both bond costs and behavior issues, players could be given the option to participate in bonded areas. Those that do not care much about behavior, but do care about the possibility of losing their bond might avoid such options or areas. Those users that do care about behavior and were willing to risk losing their bond might desire areas or options with higher behavior bonds.

The approaches and principles disclosed herein relate to computer-implemented methods and systems for processing of behavior bonds.

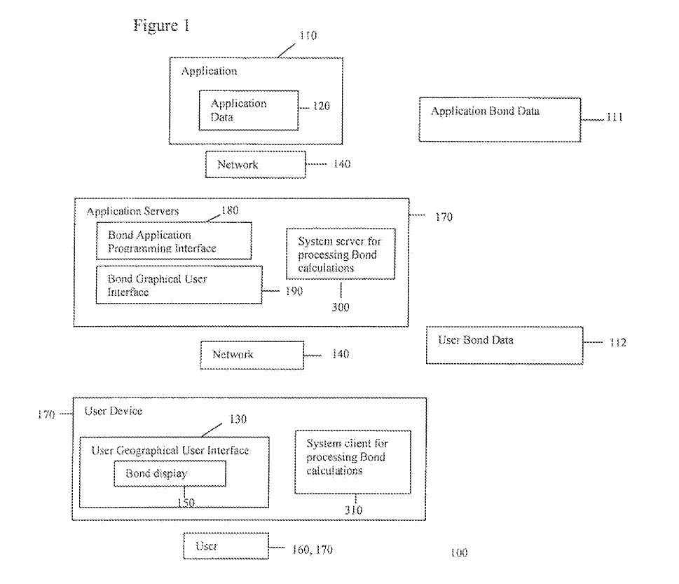

FIG. 1 is a block diagram showing an example environment 100 within which a method and system for processing of Behavior Bonds can be implemented. The example environment 100 may include am Application 110, Application Bond Data 111, User Bond Data 112, Application Data 120, a graphical user interface 130, Network 140, Bond display 150, User 160, User Device 170, Bond Application Programming Interface 180, Bond Graphical User Interface 190. The User graphical user interface 130 and bond application programming interface 180 may he associated with a server system for processing Behavior Bonds calculations 300 enabling display of the Behavior Bonds associated with a User 160. The graphical user interface 130 is for communicating with individuals, whereas the application-programming interface 180 is for communicating with computers. A user 160 may access an online resource associated via a network 140 or through a user device 170.

The network 140 may include the Internet or any other network capable of communicating data between devices.

The user device 170 may include a mobile telephone, a computer, a laptop, a smart phone, a tablet PC, and so forth. The user 160, in some example embodiments, may be a person interacting with the graphical user interface (GUI) 130 via one of the user devices 170. The user 160 may be registered with the system for processing of Behavior Bonds calculation 300 and have information on available sizes and times of the applications in the Digital store stored in a database of the system for calculating Behavior Bonds 300.

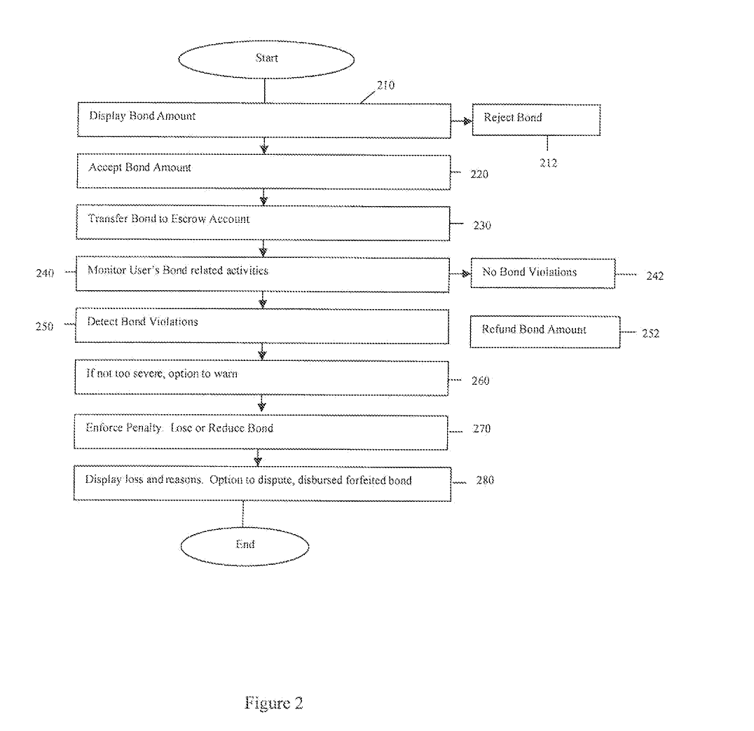

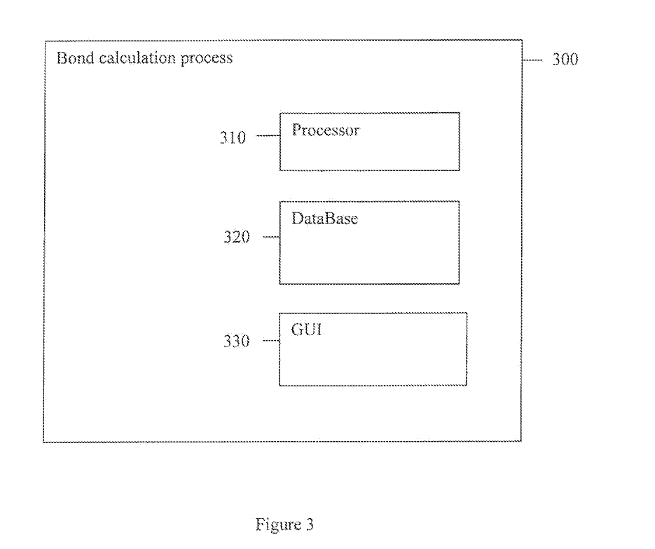

FIG. 2 shows a flow chart of a method 200 for processing of a behavior bonds calculation. The method 200 may be performed by processing logic that may comprise hardware (e.g., dedicated logic, programmable logic, and microcode), software (such as computer code executable on a general-purpose computer system or a specifically configured computer system), or a combination of both. In one example embodiment, the processing logic resides at the system 300 illustrated in FIG. 3. The method 200 may be performed by the various modules discussed above with reference to FIG. 3. Each of these modules may comprise processing logic.

As shown in FIG. 2, the amount of the bond/deposit to play the game/contest is displayed to the user at Step 210. If the bond amount is not acceptable to the user, the bond is rejected at Step 212 and the user cannot play the game or play in the contest. If the user accepts the bond at Step 220, the amount of the bond is deposited to an escrow account at Step 230 (see FIG. 3 database 320). The deposit may be done by known ways of electronic transfer. In Step 240, the user's bond related activities in relation to the multiplayer game is monitored (see processor 310 in FIG. 3). If no bond violations are determined at Step 242, then at the conclusion of the game, the bond amount is refunded to the player at Step 252. However, during playing the game, bond violations may be detected at Step 250. If the violations are not too severe, at Step 260, the player is warned. However, if the violation merits enforcement, at Step 270, depending on the severity of the violation, the player's refundable amount may be reduced or the entire deposit may be forfeited. At Step 280, the reason for the reduction in refund or forfeiture of the deposit/bond may be displayed (see FIG. 3, GUI 330) to the player along with the display of the penalty amount. The player may have the option of disputing the forfeiture. The forfeited bonds may be dispersed either to remaining players without violations or be dispersed to an escrow account or may be dispersed as a prize.

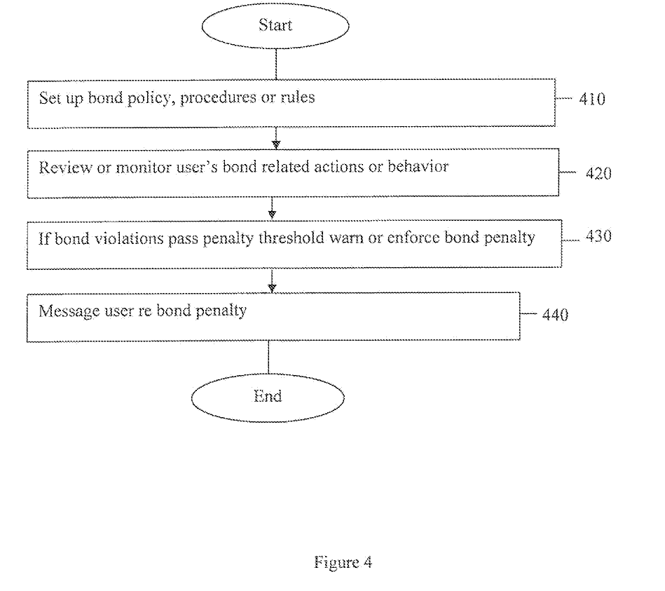

FIG. 4 shows a more detailed diagram of Step 240 in FIG. 2. First, in Step 410, the bond policy, procedures or rules associated with the game are determined. During playing of the game, in Step 420, each user's activity and behaviors that are associated with the bond are monitored (see processor 310 in FIG. 3). If a bond violation is determined to pass a penalty threshold in Step 430, a warning may be issued to the player or a penalty may be enforced against the player. A message may be displayed in Step 440 to the player about the bond penalty (see GUI 330 and FIG. 3).

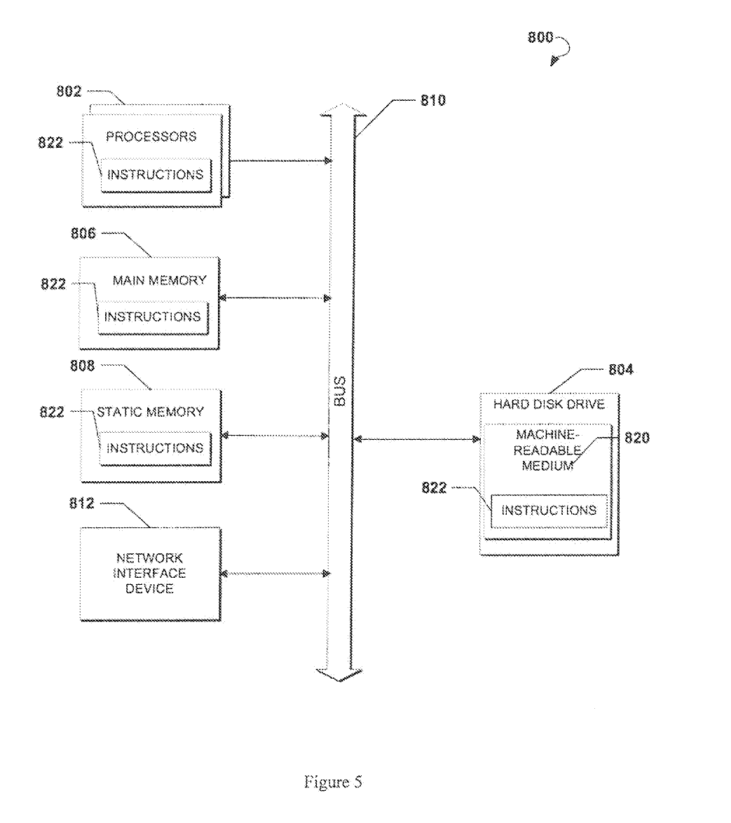

FIG. 5 is a diagrammatic representation of an example machine 800 in the form of a computer system within which a set of instructions for causing the machine to perform any one or more of the methodologies discussed herein is executed. In various example embodiments, the machine operates as a standalone device or may be connected (e.g., networked) to other machines. The machine may include its own internal database or be connected to an external database in order to provide substantially real time updates. In a networked deployment, the machine may operate in the capacity of a server or a client machine in a server-client network environment, or as a peer machine in a peer-to-peer (or distributed) network environment. The machine may he a personal computer (PC), a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 800 includes a processor or multiple processors 802 (e.g., a central processing unit (CPU), a graphics processing unit (GPU), or both), a main memory 806, and a static memory 808, which communicate with each other via a bus 810. The computer system 800 may further include a video display unit (e.g., a liquid crystal display (LCD)). The computer system 800 may also include an alphanumeric input device (e.g., a keyboard), a cursor control device (e.g., a mouse), a voice recognition or biometric verification unit (not shown), a disk drive unit 804, a signal generation device (e.g., a speaker), and a network interface device 812. The machine 800 may further include a data encryption module (not shown) to encrypt data.

The disk drive unit 804 includes a computer-readable medium 820 on which is stored one or more sets of instructions and data structures (e.g., instructions 822) embodying or utilizing any one or more of the methodologies or functions described herein. The instructions 822 may also reside, completely or at least partially, within the main memory 806 and/or within the processors 802 during execution thereof by the machine 800. The main memory 806 and the processors 802 may also constitute machine-readable media.

The instructions 822 may further be transmitted or received over a network via the network interface device 812 utilizing any one of a number of well-known transfer protocols (e.g., Hyper Text Transfer Protocol (HTTP)), While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, a system and method for processing of behavior bonds has been described. Although embodiments have been described with reference to specific example embodiments, it will be evident that various modifications and changes may be made to these embodiments without departing from the broader spirit and scope of the system and method described herein. Accordingly, the specification and drawings arc to be regarded in an illustrative rather than a restrictive sense.

What is claimed is:

1. A computer implemented method for processing behavior bonds, the method comprising the steps of:
setting bond rules for one of a platform, specific application, contest or game;
registering a user with one of the platform, application, contest or game to create user data;
determining which behavior rules the user must follow, based on the user data and bond rules;
receiving, from behavior monitoring sources, information related to user behavior for any current behavior bonds;
updating, based on user actions and reports, the current user behavior bonds status, deducting penalties as necessary;
displaying the behavior bonds remaining; and
disbursing any forfeited behavior bonds.

2. The method according to claim 1, wherein the user deposits a bond into an escrow account.

3. The method according to claim 1, further comprising the step of determining the number of rule violations for each user and display thereof.

4. The method according to claim 1, wherein forfeited bonds are shared among all users without violations.

5. The method according to claim 1, wherein forfeited bonds are dispersed as a prize.

6. The method according to claim 1, wherein the bond is used to grant additional privileges to the user.

7. The method according to claim 1, wherein the bond is associated with virtual objects.

8. The method according to claim 1, wherein if a violation is determined, warning the user about the violation.

9. The method according to claim 1, wherein if a non serious violation is determined, reducing the amount of the bond refunded to the user.

10. The method according to claim 1, wherein if a serious violation is determined, forfeiting the entire amount of the bond by the user.

11. A non-transitory computer-readable medium comprising instructions, which when executed by one or more processors, perform the following operations:
setting bond rules for one of a platform, specific application, contest or game;
registering a user with one of the platform, application, contest or game to create user data;
determining which behavior rules the user must follow, based on the user data and bond rules;
receiving, from behavior monitoring sources, information related to user behavior for any current behavior bonds;
updating, based on user actions and reports, the current user behavior bonds status, deducting penalties as necessary;
displaying the behavior bonds remaining; and
disbursing any forfeited behavior bonds.

12. The method according to claim 11, wherein the user deposits a bond into an escrow account.

13. The method according to claim 11, further comprising the step of determining the number of rule violations for each user and display thereof.

14. The method according to claim 11, wherein forfeited bonds are shared among all users without violations.

15. The method according to claim 11, wherein forfeited bonds are dispersed as a prize.

16. The method according to claim 11, wherein the bond is used to grant additional privileges to the user.

17. The method according to claim 11, wherein the bond is associated with virtual objects.

18. The method according to claim 11, wherein if a violation is determined, warning the user about the violation.

19. The method according to claim 11, wherein if a non serious violation is determined, reducing the amount of the bond refunded to the user.

20. The method according to claim 11, wherein if a serious violation is determined, forfeiting the entire amount of the bond by the user.
